(19) United States
(12) Patent Application Publication
(10) Pub. No.: US 2017/0004512 A1
(43) Pub. Date: Jan. 5, 2017

(54) SYSTEMS AND METHODS FOR CONSUMER MARKETING

(71) Applicant: Todd Weider, Fort Lauderdale, FL (US)

(72) Inventor: Todd Weider, Fort Lauderdale, FL (US)

(21) Appl. No.: 15/193,025

(22) Filed: Jun. 25, 2016

Related U.S. Application Data
(60) Provisional application No. 62/187,306, filed on Jul. 1, 2015.

(51) Int. Cl. G06Q 30/02; H04L 29/08; G06F 17/30; H04W 4/14; G06Q 20/10

(52) U.S. Cl. CPC G06Q 30/0201; H04W 4/14; G06Q 20/102; G06F 17/30268; H04L 67/02

(57) ABSTRACT

A system for marketing goods and services to consumers, including a server programmed to: receive a plurality of images, each image pertaining to goods or services available for sale from one or more vendors; generate a unique identifying code for each of the images; embed the respective unique identifying code onto each of the images; correlate each of the unique identifying codes to a unique information access reference; distribute the images with their respective embedded unique identifying codes to a plurality of consumers; receive a request from at least one of the plurality of consumers, wherein the request includes at least one unique identifying code; and responding to the request by transmitting the information access reference correlated to the at least one unique identifying code to the consumer.

### CROSS-REFERENCE TO RELATED APPLICATION

This application is related to and claims priority to U.S. Provisional Patent Application Ser. No. 62/184,306, filed Jun. 25, 2015, entitled SYSTEMS AND METHODS FOR CONSUMER MARKETING, the entirety of which is incorporated herein by reference.

### STATEMENT REGARDING FEDERALLY SPONSORED RESEARCH OR DEVELOPMENT

n/a

### FIELD OF THE INVENTION

The present invention relates to systems and methods of use thereof for marketing goods and services to consumers via various telecommunication modalities, as well as capturing and manipulating data involved therewith.

### BACKGROUND OF THE INVENTION

Advances in telecommunications and the increasingly widespread use of smartphones, tablets, and other mobile devices has brought with it increasing ease to browse and purchase goods through the internet as well as “apps” that are available on such smart phones and frequently provided by individual commercial vendors seeking to market and sell their goods. However, despite such widespread availability of smart phones, many consumers lack access to “app”-enabled smart phones and/or internet connectivity, or otherwise do not find such commercial apps or web-browsing sufficiently easy or individualized to make purchases or otherwise complete transactions using such modalities.

The present invention discloses systems and methods employing short message service (“SMS”) and other messaging platforms to market and complete transactions with such consumers.

### SUMMARY OF THE INVENTION

The present disclosure advantageously provides a method of marketing goods and services to consumers, including: receiving an image pertaining to goods or services available for sale; creating a unique identifying code corresponding to the goods or services; embedding the unique identifying code onto the image; correlating the unique identifying code to an information access reference; distributing the image with the embedded unique identifying code to one or more consumers; receiving a request from the one or more consumers, wherein the request includes the unique identifying code; and responding to the request by transmitting the information access reference to the consumer. The identifying code may include one or more keywords corresponding to the goods or services. The method may further include embedding one or more keywords corresponding to the goods or services onto the image. The information access reference may include at least one of a URL and URI. Distributing the image may include distributing the image through at least one of an SMS or MMS message. Receiving an image pertaining to goods or services available for sale may include receiving an image through at least one of an SMS or MMS message. Receiving a request from the one or more consumers may include receiving a request through at least one of an SMS or MMS message. Responding to the request may include responding to the request through at least one of an SMS or MMS message.

The image pertaining to goods or services available may be received from a vendor, and the method may include receiving a request from one or more consumers to purchase the goods or services available for sale; receiving payment information from the one or more consumers; and forwarding the purchase request and payment information to the vendor. Each of receiving the request from one or more consumers to purchase the goods or services, receiving payment information, and forwarding the purchase request and payment information may be performed through at least one of SMS or MMS messaging. Receiving a request from the one or more consumers and responding to the request may include communications sent through a messenger API, where the messenger API may include at least one of Snapchat, Kik, Facebook messenger, Viber, Whatsapp, and Wechat.

A system for marketing goods and services to consumers is provided, including a server programmed to: receive a plurality of images, each image pertaining to goods or services available for sale from one or more vendors; generate a unique identifying code for each of the images; embed the respective unique identifying code onto each of the images; correlate each of the unique identifying codes to a unique information access reference; distribute the images with their respective embedded unique identifying codes to a plurality of consumers; receive a request from at least one of the plurality of consumers, wherein the request includes at least one unique identifying code; and responding to the request by transmitting the information access reference correlated to the at least one unique identifying code to the consumer. The information access reference may include a URL. Distributing the image may include distributing the image through at least one of an SMS, MMS, or messenger API. Receiving a plurality of images may include receiving a plurality of images through at least one of an SMS, MMS, or messenger API. Receiving a request may include receiving a request through at least one of an SMS, MMS, or messenger API. Responding to the request may include responding to the request through at least one of an SMS, MMS, or messenger API. The server may be further programmed to: receive a request from one or more consumers to purchase the goods or services available for sale; receive payment information from the one or more consumers; process the payment information to receive funds for the requested purchase; forward the purchase request to the vendor; and forward at least a portion of the received funds to the vendor. Each of receiving the request from one or more consumers to purchase the goods or services, receiving payment information, and forwarding the purchase request and payment information may be performed through at least one of an SMS, MMS, or messenger API. The server may be further programmed to generate a unique consumer identifier for the consumer making the purchase request, and storing the received payment information in association with the unique consumer identifier. The server may also be programmed to generate keywords and pricing information for each of the images.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of an exemplary system for marketing goods and services to consumers via various telecommunication modalities, as well as capturing and manipulating data involved therewith in accordance with the principles of the present disclosure;

FIG. 2 is an illustration of an exemplary system and method for marketing goods and services to consumers via various telecommunication modalities, as well as capturing and manipulating data involved therewith in accordance with the principles of the present disclosure;

FIG. 3 is an illustration of a customer workflow process in accordance with the principles of the present disclosure;

FIG. 4 is an illustration of an exemplary data exchange with a customer in accordance with the principles of the present disclosure;

FIG. 5 is an illustration of an exemplary advertisement in accordance with the principles of the present disclosure;

FIG. 6 is an illustration of a consumer workflow process in accordance with the principles of the present disclosure; and

FIG. 7 is an illustration of an exemplary data exchange with a consumer in accordance with the principles of the present disclosure.

### DETAILED DESCRIPTION OF THE INVENTION

The present invention includes systems and methods of use thereof for marketing goods and services to consumers via various telecommunication modalities, as well as capturing and manipulating data involved therewith, examples of which are shown in the accompanying figures and described in more detail herein. The systems and methods of use may generally include transmitting and collecting data across various telecommunications and data platforms, such as SMS and/or MMS modalities (including but not limited to instant messaging platforms and other messenger application program interfaces (“API”) such as Snapchat, Kik, Facebook messenger, Viber, Whatsapp, Wechat or the like). The systems and methods generally include three types of parties—the marketing/data capture service provider (“provider”), the party who has goods or services available for purchase that engages the provider (“customer”), and the end user or consumer who desires to purchase the goods from the customer (“consumer”). The system and methods herein provide centralized storage and processing of images, keywords, marketing campaigns and automated messages which can then be accessed by, through or via multiple different messaging platforms without requiring any change in the images, keywords, marketing campaigns and automated messages or other data stored in the system, in addition to numerous other data collection, processing, and disbursement methods as described herein.

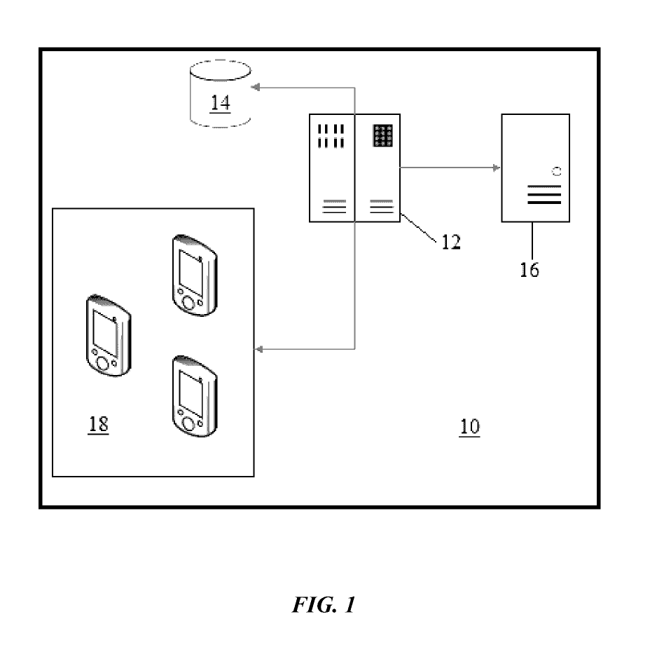

Now referring to FIG. 1, there is generally shown a System 10 for communications, marketing, and transactions generally including a server 12 operated or otherwise maintained by the provider. As used herein, the term “server” is meant to include any variation of one or more computing devices having the requisite software and/or hardware capable of performing the functions described herein. The server may include, store, or otherwise access and be in communication with an information database 14 that can store the various data, characteristics, and other information disclosed herein. The server 12 may further be in communication with one or more computing devices 16 owned, operated, or otherwise maintained and accessible to the customer(s), as well as one or more computing devices 18 owned, operated, or otherwise maintained and accessible to the consumer(s). The aforementioned computing devices may include, for example, telephones, smartphones, PDAs, tablets, laptop or desktop computers, terminals, or other means of communication.

In a general example, the customer who has goods or services for purchase may transmit or otherwise communicate an image or advertisement of the offered goods or services (via computing device(s) 16, for example) to the provider (via the server 12, for example). The provider receives the image or advertisement, and appends or modifies the image with additional information, such as a product code, keywords, pricing, description, an SMS code or number or logo of a third-party/vendor/customer messaging API, URL, URI, or other information access reference denoting where or how to access information about the offered product. The customer and/or provider may then broadcast, communicate, or otherwise distribute the modified image to potential customers through SMS or other API. Upon receiving or viewing the modified image, a consumer may then access the additional information about the goods or services through the information access reference (e.g., whether instructions, codes, URL, and/or URI appended to the image or sent in addition to the image). While accessing the additional information, the consumer may then provide additional information about themselves, their purchasing habits, and/or any other demographic or product/purchase-relevant information to the customer and/or provider, which may be stored in the database 14 of the system 10 along with any message or communication metadata.

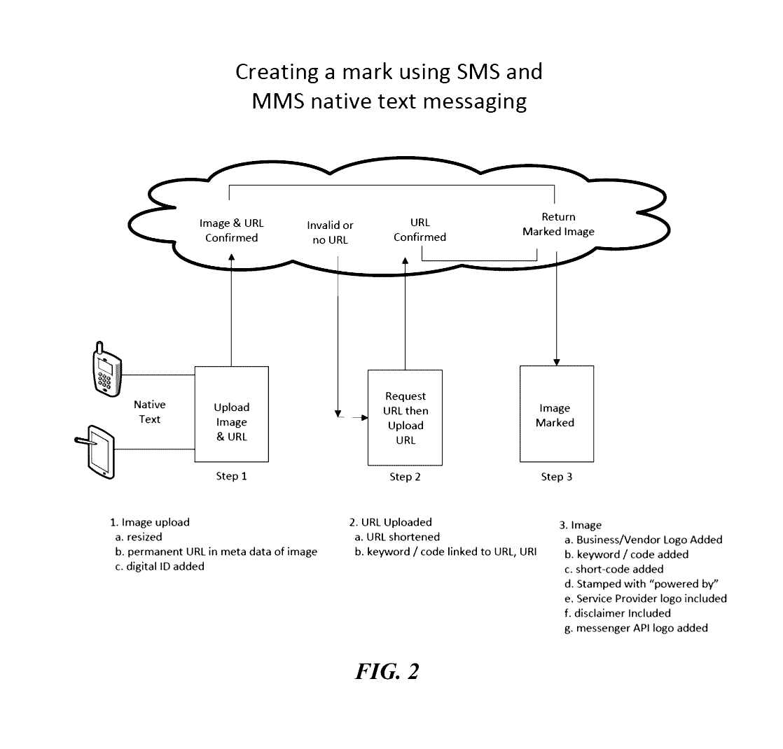

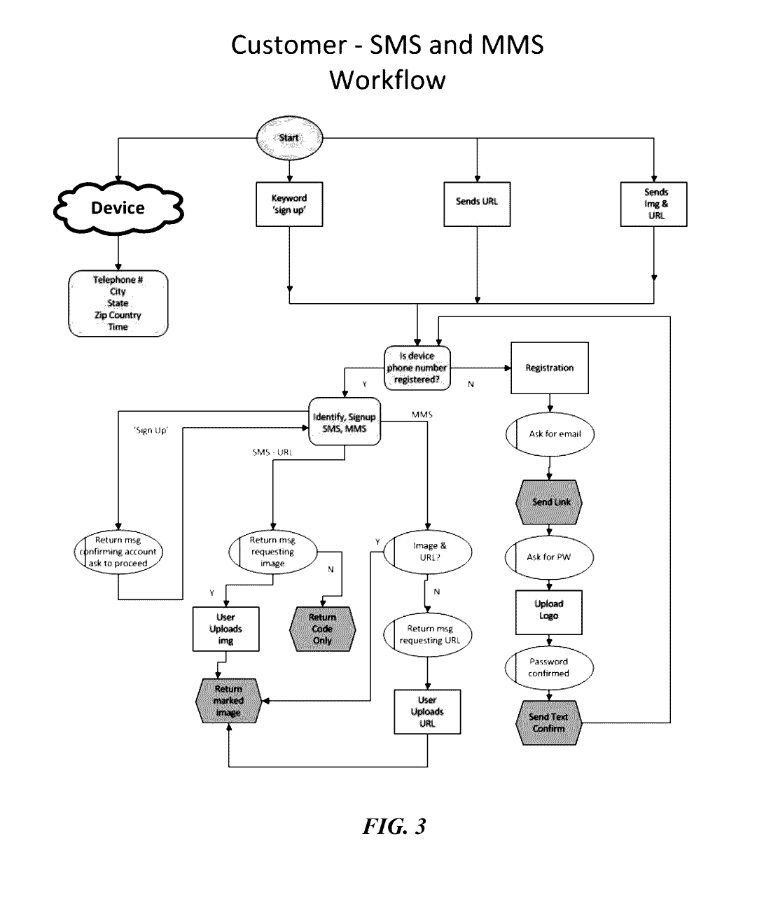

Now referring to FIG. 2, an exemplary system and method constructed in accordance with the principles of the present disclosure is shown. In Step 1, the customer uploads or transmits an image pertaining to goods or services offered for sale. The image may be uploaded electronically through one or more networks or other communications means from a smart phone, tablet, or other transmitting device to the marketing service provider. The customer may also provide a desired URL or other information or identifier to be appended to the image for later access by a consumer. The service provider receives the image, may resize or modify the image to increase efficient loading or display on various other devices, embed the URL and other identifying information onto the image, and add a unique identifier or digital ID. In Step 2, the service provider may shorten the URL provided by the customer and may link the digital ID or other keyword or code (such as an SMS number, logo or identifier of a messaging API) to the URL. In Step 3, the service provider finalizes the modified image to also include a business logo of the service provider and/or customer, add the keyword or other short code, and include other information such as a disclaimer. FIG. 3 is a flow chart showing an exemplary process of gathering information from the customer and generating a modified image in more detail.

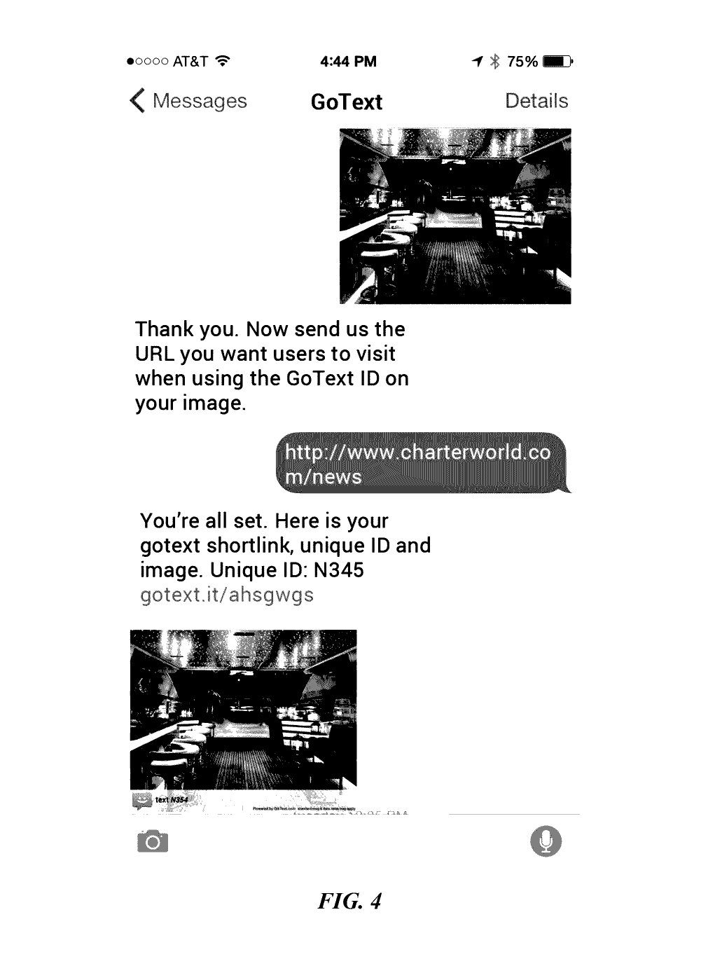

FIG. 4 is an illustration of an exemplary communication exchange between the customer offering goods or services for sale and the service provider. The customer sends an image of goods/services offered for sale to the service provider. The customer also sends additional information, such as a URL, where additional information can be accessed about the goods. The service provider then issues a unique identifier for the goods or services, and associates the unique identifier with the product and URL, and may further provide a shortened URL or other information access codes/addresses to the customer. A modified image of the goods/services is then generated that includes all of the information discussed above.

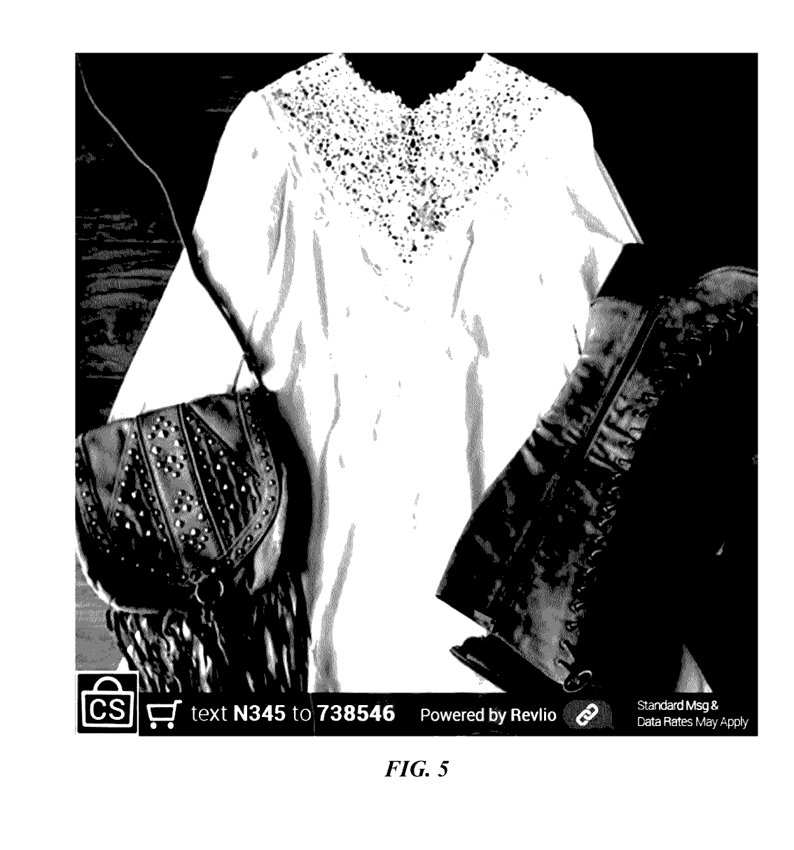

FIG. 5 shows an exemplary image modified by the service provider in accordance with the principles of the present disclosure. The image has been modified by the service provider to include a unique digital ID (e.g., “N345”) that is associated with the goods/services displayed or advertised in the image (e.g., clothing). The digital ID may be associated with a URL, keywords, pricing, descriptions related to that customer, or other information about the goods or services stored in a database (not shown) maintained by the service provider and accessible or communicable to the consumer upon request. The modified image further includes an SMS number (e.g., “738546”) or logo of a messenger API provider that a potential consumer of the goods/services can contact to receive additional information about the goods or services (e.g., such as a URL or other information that the service provider stores/maintains in association with the goods/services). The modified image may also include the logo of the service provider (e.g., “Powered by Revlio”), a logo of the customer, and/or a logo of a third-party messenger API provider.

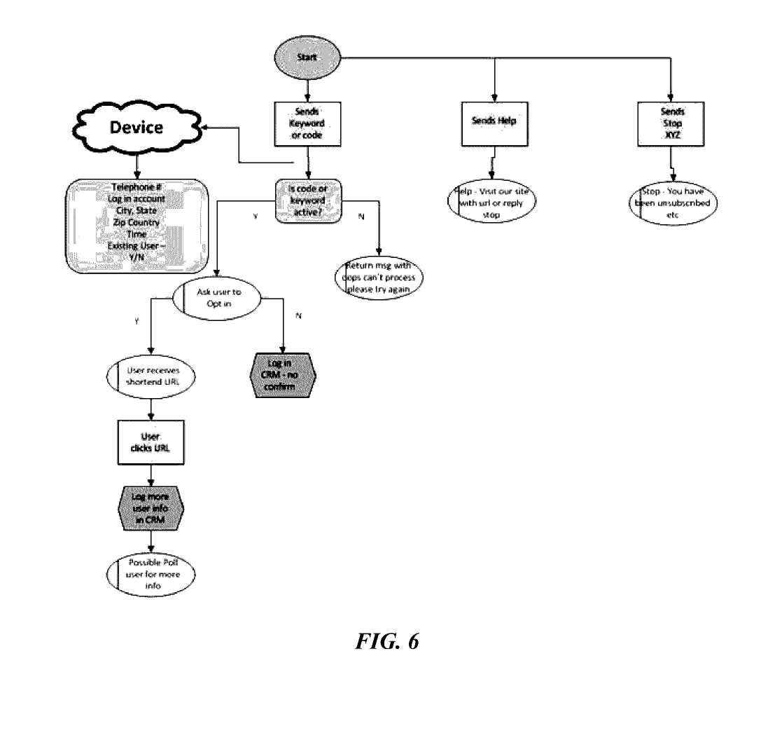

FIG. 6 is a flow chart of communications and data exchanged between the service provider and a consumer who may be interested in purchasing the goods or services provided by the customer. The customer may provide various information about themselves, such as telephone number, email address, location, etc. to the service provider and/or may have an account containing such information with the provider. Additional consumer information provided to and/or solicited by the provider may include consumer data through polling or surveys, whether the consumer is insured or not insured, marriage status, age, habits, travel frequency, income, number of sessions/exchanges or transactions with the provider, frequency of exchanges or transactions with the provider, product categories of interest—clothing, cars, etc. The consumer may send the keywords or code listed on a particular modified image that the customer viewed to the service provider. Upon receipt of the code or keyword from the consumer, the service provider sends the information associated with the keyword or code, which may include a URL or other informational access information.

The system 10 may further enable a consumer to send keywords regarding desired products or services, or even other users to the service provider independently of a service-provider generated prompt or advertisement. For example, the consumer may send a keyword about a product to the server 12 via the computing devices 18. The server 12 would then access or query the database 14 for any products matching or related to the received keyword. If the database 14 fails to identify sufficient results, then the server 12 may then access external, third-party information sources, for example on the internet or through other search means, to identify goods or services pertinent to the keyword provided by the consumer, and deliver URL's, images, pricing, or product descriptions and information directly to the consumer. The system 10 may also sort and/or categorize multiple available goods/services options depending on a cost or commission basis. Similar searching methods could be initiated to locate information on other consumers, or to locate the actual position of a consumer, using the system. For example, a consumer could send a message containing a “locate” command or other preset initiation message, and one or more details about the sought-after consumer, e.g., “locate @bobsmith”, and information, profile details, GPS location, and/or other stored or identified characteristics of the user “Bob Smith” would be queried by the server 12 and delivered to the consumer that sent the request.

The system 10 may further enable a consumer to seek other goods and services having predetermined, predefined similarities with the products that were generated in relation to the consumer's keyword submission to the system. For example, the consumer may message the server 12 the text “more like this” which prompts the server 12 to query the database 14 and/or other sources to identify one or more goods/or related to the original goods and services identified by the system 10.

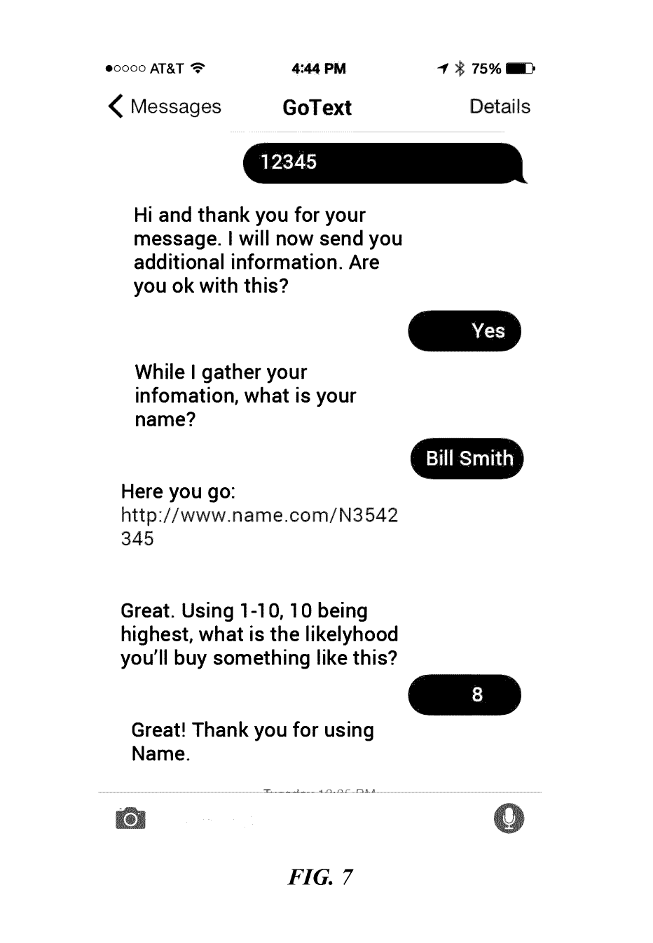

FIG. 7 is an exemplary communication using SMS, MMS, or messaging API between the consumer and the service provider requesting the additional information about the viewed goods/services image (e.g., code “12345”), where the service provided provides the info associated with the goods (e.g., URL, website link), as well as the service provider requesting additional information from the consumer (e.g., likelihood of buying product). In addition to and/or alternatively to expressly requesting information from the consumer, analytics and data regarding consumer use of the shortened URL may be captured, monitored, and/or tracked by the provider (for example, the number of time the URL has been clicked, countries or regions where the URL was accessed, which browser or technology platforms were used to access the URL, etc.). The provider may also identify and communicate the availability of other goods/services that the consumer may be interested in based upon the consumer's selection of a particular good or service.

The systems and methods disclosed herein may further include integration and/or interaction with a product/service inventory system showing current availability, location, and other current information that can facilitate or accelerate purchase or delivery of the goods or service to the consumer. For example, when the consumer requests additional information from the provider regarding the goods or services, the provider may solicit or gather location information from the consumer (e.g. such as GPS data from a smart phone or other device), and then the provider can communicate the location nearest to the consumer where the goods or services are located. The provider may also identify other consumers who have purchased the particular goods at issue within a given proximity to the consumer's location, where the provider provides an option or ability to communicate with these other consumers about the particular products or services prior to purchasing. In addition, the system 10 may enable communication between consumers that is facilitated by and includes content from the system, such via server 12. For example, when a consumer received information for goods or services that a first consumer seeks to share with other consumers, the first consumer may communicate a share or forwarding keyword or command (e.g., “share,” or “fwd”, or by selecting a link, menu command, or “button” within a messenger API) and one or more identification parameters of another second consumer with (e.g., “@bobsmith”) that signals the system to forward the same goods and services content to the other, second consumer.

It is also contemplated that the computing devices 18 of system 10 may include simplified “one-touch” wifi or Bluetooth enabled communication devices that are pre-programmed with consumer identification or account information, as well as a hashcode, UPC, brand-name, keyword, or URL that, when activated or pressed, relays a stored message or initiates a preset sequence of events (such as the ordering of a particular good or service) by the service provider (via the server 12). Receipt of the stored messages and/or confirmation of completion of the preset sequence of events may be confirmed by the server 12 via one or more messages to the consumer through the system 10. Such “one-touch” devices may facilitate ordering discrete goods or services on a recurring basis as needed, requesting service on a specific piece of equipment, sending a specific message (e.g., “I'm Ok”) to a designated recipient via the server 12, etc.

Another exemplary use or method of the systems and processes disclosed herein may include providing information, products, and/or services associated with an athlete, sports figure, or other individual involved in a competition. Such athletes or sports figures may include, for example, professional football, basketball, baseball, golf, and/or soccer players, Olympians or other participants in sports competitions, poker players, or the like. The provider may define or otherwise associate a unique identifier for each athlete or sports figure, and the unique identifier may include, for example, an indication or abbreviation of the athlete's sport, team, position, and/or jersey number. The unique identifier may also be correlated to one or more keywords descriptive of the athlete's sport, team, position. For example, a professional football player playing for the Miami Dolphins that wears jersey number 17 may have a unique identifier or code of “MD17.” One or more keyword searches may also be used to search for the unique identifier and resulting athlete information. For example, a consumer query of “Miami Quarterback” may result in a response including the unique identifier “MD17” and corresponding information, products, or services available in association with that athlete, or related athletes having a similar position, team, and/or jersey number. A plurality of such unique codes or identifiers may be stored by the provider in association with a plurality of various sports figures about which the provider can provide related information, goods, and/or services. The related information, goods, and/or services associated by the provider with the unique identifier may be such information, services, and/or goods available for distribution and/or sale by a customer. Exemplary customers having such information and/or goods or services for sale may include, for example, the owners of professional sports teams, sports leagues (e.g., NFL, NBA, MLB, or the like); sport venues (e.g., stadiums, arenas, or the like); and/or sports-related service providers (e.g, fantasy football, baseball, or basketball service providers, gambling or sports wagering services, or the like).

In an exemplary SMS, MMS, or messenger API communication between the service provider and a consumer who may be interested in receiving information (such as statistics, player profiles, career history, etc.) and/or purchasing goods or services provided by the customer related to a particular sports player, the consumer may send a keyword or code (e.g., the unique identifier associated with the sports figure) listed on a particular modified image or advertisement that the customer viewed to the service provider. The image and/or advertisement may have been viewed, for example, on a “jumbotron” or other viewing screen within a venue or arena where a sporting event is taking place. Such advertisements may have been modified by the service provider to include the unique identifier or code in conjunction with the customer-provided content as described above.

Upon receipt of the code or keyword from the consumer, the service provider sends the information associated with the keyword or code, which may include a URL or other information to the consumer. The URL may include the aforementioned information about the sports figure, and/or may include goods or services associated with the sports figure that are available for purchase, such as tickets to future events where the sports figure will attend/compete, jerseys, clothing, memorabilia, or the like. The consumer may also elect or subscribe to additional informational updates about the particular sports figure provided by the customer and/or service provider in the future.

The system 10 may also collect, store, and process customer payment information along with goods or services information (e.g., in-stock status, available locations, etc.) to facilitate expedient transactions through a messenger platform interface with the server 12. For example, after viewing an image(s) of available goods/services with price, description, location or the like, a user/consumer could purchase the viewed product from the customer by replying “yes” or providing other indication via the messaging app. The consumer would then be charged by the service provider for the purchase with their credit, debit or bank account information already on file in the database 14, or would be prompted to enter such payment information. The service provider (via the server 12, for example) would then in turn process the order and convey the transaction details to the third-party customer, along with payment and shipping information for delivery (or alternatively, the service provide may process payment and receive funds, then forward at least a portion of the funds to the customer/vendor, while retaining a portion of the funds as a commission and/or transaction fee). The consumer would not have to exit the messaging application, nor would they have to enter credit-card, address or other personal information into a third party website or application.

The system 10 may also enable the service provider to interconnect the customer and consumer directly through the server 12, for example, or through a messenger API or routing of SMS or MMS messages via the system 10. As such, in situations where the customer may seek additional assistance or information regarding ordered goods or services, or other issues where the customer may desire to communicate directly with the consumer, the service provider may receive a message from either the customer or consumer with the respective unique identifier(s) of the consumer or customer they desire to contact. Upon receipt of the request and the identifier(s), the service provider may route messages directly to the designated, sought-after customer or consumer, who can then communicate in real-time via the SMS, MMS, and/or messaging API routed through the service provider's system.

The present invention can be realized in hardware, or a combination of hardware and software. Any kind of computing system, or other apparatus adapted for carrying out the methods described herein, is suited to perform the functions described herein. A typical combination of hardware and software could be a specialized computer system, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Storage medium refers to any volatile or non-volatile computer readable storage device such as magnetic storage, semiconductor memory, DVD, Compact Disk or memory stick, but does not encompass a signal propagation media such as a copper cable, optical fiber or wireless transmission media. Program code may be transmitted to a computer constructed in accordance with the principles of the present invention using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. It is noted that the computer programs of the present invention can be downloaded via the Internet to a computer

It will be appreciated by persons skilled in the art that the present invention is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the examples disclosed herein are not necessarily exclusive of each other and may be included in a variety of different combinations or configurations without departing from the scope and spirit of the invention. A variety of modifications and variations are possible in light of the above teachings without departing from the scope and spirit of the invention, which is limited only by the following claims.

What is claimed is:

1. A method of marketing goods and services to consumers, comprising:
receiving an image pertaining to goods or services available for sale;
creating a unique identifying code corresponding to the goods or services;
embedding the unique identifying code onto the image;
correlating the unique identifying code to an information access reference;
distributing the image with the embedded unique identifying code to one or more consumers;
receiving a request from the one or more consumers, wherein the request includes the unique identifying code; and
responding to the request by transmitting the information access reference to the consumer.

2. The method of claim 1, wherein the identifying code includes one or more keywords corresponding to the goods or services.

3. The method of claim 1, further comprising embedding one or more keywords corresponding to the goods or services onto the image.

4. The method of claim 1, wherein the information access reference is at least one of a URL and URI.

5. The method of claim 1, wherein distributing the image includes distributing the image through at least one of an SMS or MMS message.

6. The method of claim 1, wherein receiving an image pertaining to goods or services available for sale includes receiving an image through at least one of an SMS or MMS message

7. The method of claim 6, wherein receiving a request from the one or more consumers includes receiving a request through at least one of an SMS or MMS message.

8. The method of claim 7, wherein responding to the request includes responding to the request through at least one of an SMS or MMS message.

9. The method of claim 1, wherein the image pertaining to goods or services available is received from a vendor, the method further comprising:
receiving a request from one or more consumers to purchase the goods or services available for sale;
receiving payment information from the one or more consumers; and
forwarding the purchase request and payment information to the vendor.

10. The method of claim 9, wherein each of receiving the request from one or more consumers to purchase the goods or services, receiving payment information, and forwarding the purchase request and payment information is performed through at least one of SMS or MMS messaging.

11. The method of claim 1, wherein receiving a request from the one or more consumers and responding to the request includes communications sent through a messenger API.

12. The method of claim 11, wherein the messenger API includes at least one of Snapchat, Kik, Facebook messenger, Viber, Whatsapp, and Wechat.

13. A system for marketing goods and services to consumers, comprising:
a server programmed to:
receive a plurality of images, each image pertaining to goods or services available for sale from one or more vendors;
generate a unique identifying code for each of the images;
embed the respective unique identifying code onto each of the images;
correlate each of the unique identifying codes to a unique information access reference;
distribute the images with their respective embedded unique identifying codes to a plurality of consumers;
receive a request from at least one of the plurality of consumers, wherein the request includes at least one unique identifying code; and
responding to the request by transmitting the information access reference correlated to the at least one unique identifying code to the consumer.

14. The system of claim 13, wherein the information access reference is a URL.

15. The system of claim 13, wherein distributing the image includes distributing the image through at least one of an SMS, MMS, or messenger API.

16. The system of claim 13, wherein receiving a plurality of images includes receiving a plurality of images through at least one of an SMS, MMS, or messenger API, wherein receiving a request includes receiving a request through at least one of an SMS, MMS, or messenger API, and wherein responding to the request includes responding to the request through at least one of an SMS, MMS, or messenger API.

17. The system of claim 13, wherein the server is further programmed to:
receive a request from one or more consumers to purchase the goods or services available for sale;
receive payment information from the one or more consumers;
process the payment information to receive funds for the requested purchase;
forward the purchase request to the vendor; and
forward at least a portion of the received funds to the vendor.

18. The system of claim 17, wherein each of receiving the request from one or more consumers to purchase the goods or services, receiving payment information, and forwarding the purchase request and payment information is performed through at least one of an SMS, MMS, or messenger API.

19. The system of claim 17, wherein the server is further programmed to generate a unique consumer identifier for the consumer making the purchase request, and storing the received payment information in association with the unique consumer identifier.

20. The system of claim 17, wherein the server is further programmed to generate keywords and pricing information for each of the images.
